(19) United States
(12) Patent Application Publication
(10) Pub. No.: US 2014/0021220 A1
(43) Pub. Date: Jan. 23, 2014

(54) WATER GENERATOR UTILIZING AN AIR CONDITIONER SYSTEM

(71) Applicant: James W. Windham, Loxahatchee, FL (US)

(72) Inventor: James W. Windham, Loxahatchee, FL (US)

(21) Appl. No.: 14/033,395

(22) Filed: Sep. 20, 2013

Related U.S. Application Data
(63) Continuation-in-part of application No. 12/500,500, filed on Jul. 9, 2009, now abandoned.

(51) Int. Cl. B67D 1/08

(52) U.S. Cl. CPC B67D 1/08
USPC 222/1; 222/189.11

(57) ABSTRACT

A method and system for generating and providing drinking water is provided. The method for providing drinking water includes collecting condensed water from an air conditioner unit, storing in a tank the water that was collected, filtering the water so as to eliminate contaminants, sensing a pressure drop in a pressurized water generation system and activating an on-demand water pump so as to send the water to a faucet for dispensation. A water generator for providing drinking water includes a tank adapted to collect condensed water from a previously installed air conditioner unit, a pressurized water generator assembly, a sensor adapted to sense a pressure drop in the pressurized water generator assembly, a filter adapted to eliminate contaminants from the water collected in the tank and an on-demand water pump adapted to send the water to a faucet for dispensation.

### CROSS-REFERENCE TO RELATED APPLICATIONS

This patent application claims the benefit of pending U.S. Non-Provisional patent application Ser. No. 12/500,500, filed on Jul. 9, 2009, entitled WATER GENERATOR UTILIZING AN AIR CONDITIONER SYSTEM, the entire teachings of all of which are incorporated by reference herein.

### STATEMENT REGARDING FEDERALLY SPONSORED RESEARCH

Not Applicable.

### INCORPORATION BY REFERENCE OF MATERIAL SUBMITTED ON CD

Not Applicable.

### BACKGROUND OF THE INVENTION

1. Field of the Invention

The present invention relates to the field of drinking water generation systems and more particularly to drinking water generation systems configured for integration with an air conditioner system.

2. Description of the Related Art

Water is a natural resource currently under threat around the world. This critical resource is already in short supply across parts of the world and will become even scarcer in the coming decades. Increases in water scarcity arise from different causes. First and foremost, the enormous growth in human population has had a dramatic effect on water levels due to human consumption. In the last century, the world population has tripled and it is expected to rise from the present 6.5 billion to 8.9 billion by 2050. Water scarcity will intensify accordingly. Second, the economic development and urbanization of the world has called for increased allocations of water for domestic, agriculture and industrial sectors. As industry worldwide grows, so does water consumption. Lastly, climate change has impacted the amount of drinking water available for use by humans.

Various conventional systems for extracting drinking water from the air are available. These systems generally use an apparatus that enables the condensation process to occur, thereby producing a condensate that is harvested as pure drinking water. An air conditioner system, for example, naturally produces a condensate as it cools air. At least one known system for extracting drinking water from the air operates by using the condensate from an air conditioning unit, and further includes a water treatment or water purification step. The process of extracting drinking water from the air is advantageous since it eliminates the need for access to groundwater or seawater and the ambient air is a sustainable and accessible resource.

The approaches above, however, stop short of providing a method for delivering the collected drinking water to a user. Previous solutions provide a solution for water extraction from air wherein the extracted water is generally collected in a container or other type of repository. But conventional approaches do not provide a solution for delivering the water to users in a convenient way. That is, although previous approaches have addressed the problem of extracting potable drinking water from the ambient air, previous approaches have not sufficiently dealt with the issue of providing the collected water to individuals for use.

Therefore, there is a need to overcome the deficiencies with the prior art and more particularly for a more efficient way to generate drinking water from an air conditioner system and provide it for use.

### BRIEF SUMMARY OF THE INVENTION

Embodiments of the present invention address deficiencies of the art in respect to water generation and provide a novel and non-obvious method and system for generating and providing drinking water. In an embodiment of the invention, the method for providing drinking water includes collecting condensed water from an air conditioner unit, storing in a tank the water that was collected, filtering the water so as to eliminate contaminants, sensing a pressure drop in a pressurized water generation system and activating an on-demand water pump so as to send the water to a faucet for dispensation.

In another embodiment of the invention, a water generator for providing drinking water can be provided. The water generator can include a tank for collecting condensed water from an air conditioner unit, a water generator assembly residing in a first housing that is separate from a second housing in which the previously installed air conditioner unit resides, where the water generator assembly is a pressurized water generator assembly, a sensor adapted to sense a pressure drop in the pressurized water generator assembly, a filter for eliminating contaminants from the water collected in the tank and an on-demand water pump for sending the water to a faucet for dispensation. In an aspect of this embodiment, the water generator assembly resides in a first housing that is separate from a second housing in which the previously installed air conditioner unit resides.

In yet another embodiment of the invention, an alternative water generation system for providing drinking water can be provided. The water generation system for providing drinking water includes a previously installed air conditioner unit, a tank adapted to collect condensed water from the previously installed air conditioner unit, a pipe adapted to transfer the condensed water from the previously installed air conditioner unit to the tank, a pressurized water generator assembly, a sensor adapted to sense a pressure drop in the pressurized water generator assembly, a filter adapted to eliminate contaminants from the water collected in the tank and an on-demand water pump adapted to send the water to a faucet for dispensation. In an aspect of this embodiment, the water generator assembly resides in a first housing that is separate from a second housing in which the previously installed air conditioner unit resides.

Additional aspects of the invention will be set forth in part in the description that follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 an illustration of a block diagram showing a drinking water generation system 100 in accordance with the principles of the present invention; and

FIG. 2 an illustration of a block diagram showing more detail of the water generator assembly in accordance with the principles of the present invention.

### DETAILED DESCRIPTION OF THE INVENTION

Embodiments of the present invention address deficiencies of the art in respect to generation of drinking water and provide a novel and non-obvious method and system for generating drinking water and providing it for use. The present invention improves upon the prior art by providing a drinking water generation system that collects condensate from an air conditioner unit into a tank, filters the water for contaminants, senses a pressure drop in a pressurized water generator assembly and then utilizes an on-demand water pump to send the water to a faucet for dispensation. In one embodiment, the on-demand water pump may send the water through the filter, thereby eliminating contaminants from the water, and then to the faucet for dispensation. In another embodiment, the on-demand water pump may be activated only when the faucet is activated such as by the opening of a valve of the faucet. In yet another embodiment, the on-demand water pump may be de-activated when the water level in the tank falls below a predefined threshold. In another embodiment, the water generation system for providing drinking water includes a previously installed air conditioner unit, a tank adapted to collect condensed water from the previously installed air conditioner unit, a pipe adapted to transfer the condensed water from the previously installed air conditioner unit to the tank, a pressurized water generator assembly, a sensor adapted to sense a pressure drop in the pressurized water generator assembly, a filter adapted to eliminate contaminants from the water collected in the tank and an on-demand water pump adapted to send the water to a faucet for dispensation. In an aspect of this embodiment, the water generator assembly resides in a first housing that is separate from a second housing in which the previously installed air conditioner unit resides.

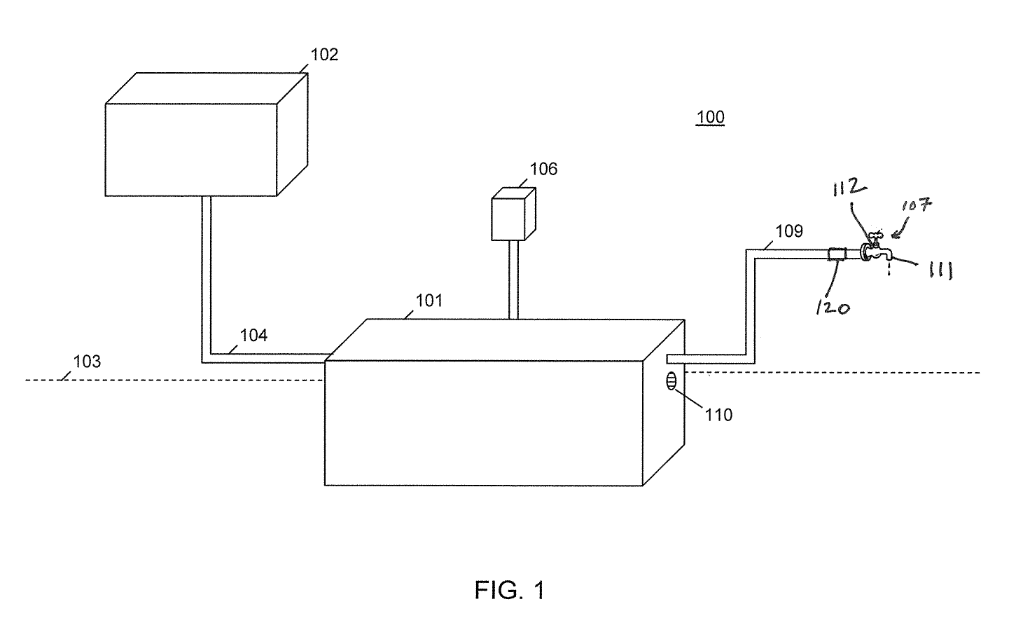

Referring now to the drawing figures in which like reference designators refer to like elements, there is shown in FIG. 1 an illustration of a block diagram showing a drinking water generation system 100 in accordance with the principles of the present invention. FIG. 1 shows an air conditioner unit 102 that produces a condensate, such as water that collects in the air conditioner unit 102 during the condensation process inherent in the functionality of the air conditioner 102. A pipe 104 may transfer the condensate from the air conditioner 102 to the water generator assembly 101. In one embodiment, the pipe 104 comprises a ¾ inch width pipe formed of copper, steel, iron, aluminum, or a plastic compound such as polyvinyl chloride (PVC), chlorinated polyvinyl chloride (CPVC), polypropylene (PP), polyethylene (PE), cross-linked high-density polyethylene (PEX), polybutylene (PB), and acrylonitrile butadiene styrene (ABS).

In another embodiment, the pipe 104 transfers the condensate from the air conditioner 102 to the water generator assembly 101 using gravity as an aid. In yet another embodiment, the pipe 104 transfers the condensate from the air conditioner 102 to the water generator assembly 101 using a water pump (not shown). Further, the pipe 104 may travel from an outdoor air conditioner 102 to an indoor water generator assembly 101, or vice versa.

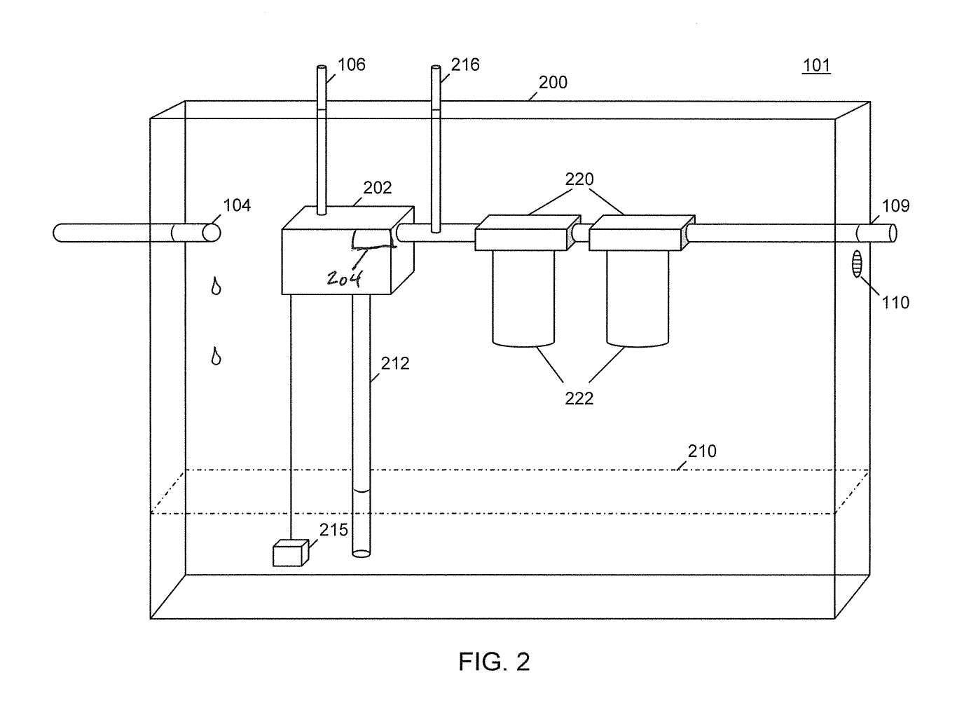

The water generator assembly 101 may be located indoors or outdoors and may be positioned below the air conditioner system 102. The water generator assembly 101 may further be recessed into the floor 103 or ground, so as to be completely or partially lower than the floor line and allow gravity to assist in the feed process of the water. The drinking water production processes conducted within water generator assembly 101, as well as more detail on the interior of water generator assembly 101, are provided below in greater detail with reference to FIG. 2.

The water generator assembly 101 produces filtered drinking water that is pumped out via a pipe 109 to a faucet 107 for dispensation. Pipe 109 transfers the filtered drinking water from the water generator assembly 101, which may be either indoors or outdoors, to faucet 107, which also may be either indoors or outdoors. Pipe 109 may comprise some or all of the features described for pipe 104. Faucet 107 may be located indoors or outdoors and may comprise any conventional spigot or tap to control the release of a liquid. In this sense, faucet 107 has both a spout 111 and a valve 112 to regulate delivery of a fluid at the end of a pipe 109. An electrical line 106 provides electricity, such as 120V, to the contents of the water generator assembly 101. A sensor 120 can be in fluid communication, located, positioned or inline with pipe 109 to sense when faucet 107 is activated, i.e., a valve 112 of faucet 107 is opened from a closed position to an open position. An overflow valve 110 is also shown, which is described in greater detail below with reference to FIG. 2.

FIG. 2 an illustration of a block diagram showing more detail of the water generator assembly 101 in accordance with the principles of the present invention. FIG. 2 shows that water generator assembly 101 comprises a tank 200 which may, for example, be formed of a plastic compound, such as that described for pipe 104, and hold a quantity of water e.g., twenty gallons. In one embodiment of the present invention, the tank 200 is hermetically sealed so as to isolate the contents of the tank 200 from its exterior. To this end, the faucet 107 may include a vacuum breaker or backflow preventer so that the water cannot return through the pipe 109. Additionally, water cannot travel back through the pump 202 into the tank 200. This serves to ensure that the water 210 collected in tank 200 is not contaminated by outside contaminants.

FIG. 2 further shows that the water generator assembly 101 includes an on-demand water pump 202, which pumps water 210 out of the tank 200 on demand. The on-demand water pump 202 sucks in water 210 using pipe 212 and subsequently pumps the water 210 out of the tank 200. Pipe 212 may comprise some or all of the features described for pipe 104. In one embodiment of the present invention, the on-demand water pump 202 is activated to pump water out of the tank 200 only when the faucet 107 is activated. In this embodiment, a sensor 204 in the on-demand water pump 202 senses when the faucet 107 is activated, that is when the valve of faucet 107 is opened and subsequently activates the on-demand water pump 202 to pump water out of the tank 200. This sensor 204 may, for example, comprise a pressure sensor that senses when the pressure in pipe 109 falls due to the opening of the faucet 107. In this embodiment, the on-demand pump 202 upon sensing a pressure drop after the faucet 107 is opened can automatically activate the pump 202 to maintain a constant pressure in the pressurized system 100 at a predetermined pressure, e.g., 30 psi, 42 psi, etc. An electrical line 106 provides electricity, such as 120V, to the on-demand water pump 202 of the water generator assembly 101.

In another embodiment of the present invention, the on-demand water pump 202 is de-activated when sensor 215 senses that the water level within the tank 200 falls below a predefined threshold. Sensor 215 may, for example, comprise a float switch that senses when a water-floating element within sensor 215 falls below a predefined position, thereby deactivating the on-demand water pump 202.

FIG. 2 further shows that the water generator assembly 101 includes filter assembly 220 that removes contaminants from the water 210 when it is pumped through the filter assembly 220. In one embodiment of the present invention, the on-demand water pump 202 pumps water 210 from the water tank 200 through the filter assembly 220, thereby producing filtered drinking water that is further pumped to the faucet 107 via pipe 109. In another embodiment of the present invention, the filter assembly 220 includes one or more filters 222 that may comprise activated carbon to remove contaminants and impurities from water 210 utilizing chemical adsorption. In another embodiment of the present invention, the filter assembly 220 includes a bacterial agent that removes bacteria from the water 210, such as a light that irradiates bacteria with lethal radiation.

In one embodiment of the present invention, the tank 200 includes an overflow valve 110 that allows water 210 to escape from the tank 200 when the water level within the tank 200 rises above a predefined level. Overflow valve 110 may, for example, comprise an opening at a particular water level, wherein the opening allows water to flow out of the tank 200 when the water level reaches the opening and wherein the opening includes a screen, a check valve, and/or other obstruction to prevent the ingress of contaminants and/or insects into the tank 200.

In another embodiment of the present invention, the on-demand water pump 202 includes a directional flushing valve 216 that allows a user to empty and clean the assembly 101 for storage or extended periods of non-use. Directional flushing valve 216 may, for example, comprise an opening that allows water to flow out when emptying water from the water generator assembly 101 is necessary.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for providing drinking water, the method comprising:
collecting condensed water from an air conditioner unit;
storing the water that was collected in a tank;
filtering the water so as to eliminate contaminants;
sensing a pressure drop in a pressurized water generator assembly; and
activating an on-demand water pump to send the water to a faucet for dispensation.

2. The method of claim 2, wherein the step of collecting further comprises collecting condensed water from the air conditioner unit and transferring the water via a pipe to the tank.

3. The method of claim 2, wherein the step of filtering further comprises activating the on-demand water pump so as to send the water in the tank through the filter.

4. The method of claim 3, wherein the step of activating further comprises sensing that a valve of the faucet has been opened and activating the on-demand water pump so as to send the water to the faucet for dispensation.

5. The method of claim 3, wherein the step of activating further comprises sensing that a valve of the faucet has been opened and activating the on-demand water pump so as to send the water in the tank through the filter and to the faucet for dispensation.

6. The method of claim 4, further comprising deactivating the on-demand water pump when the tank is empty.

7. A water generator comprising:
a tank adapted to collect condensed water from a previously installed air conditioner unit;
a pressurized water generator assembly;
a sensor adapted to sense a pressure drop in the pressurized water generator assembly;
a filter adapted to eliminate contaminants from the water collected in the tank; and
an on-demand water pump adapted to send the water to a faucet for dispensation.

8. The water generator of claim 7, wherein the water generator assembly resides in a first housing that is separate from a second housing in which the previously installed air conditioner unit resides.

9. The water generator of claim 8, further comprising a pipe for transferring condensed water from the air conditioner unit to the tank.

10. The water generator of claim 9, wherein the filter comprises a carbon material.

11. The water generator of claim 9, wherein the on-demand water pump is connected to the filter so as to send the water in the tank through the filter and to the faucet for dispensation.

12. The water generator of claim 7, further comprising a pipe for transferring the water from the on-demand water pump to the faucet.

13. The water generator of claim 7, further comprising a sensor connected to the on-demand water pump, wherein the sensor activates the on-demand water pump upon sensing a drop in pressure in the pressurized water generator assembly that results from the activation of a valve of the faucet.

14. The water generator of claim 7, further comprising a water level sensor connected to the on-demand water pump, wherein the water level sensor de-activates the on-demand water pump upon sensing a water level in the tank is below a predefined threshold.

15. The water generator of claim 7, further comprising an overflow valve that allows water in the tank to exit the tank when a water level in the tank exceeds a predefined threshold.

16. A water generation system, comprising:
a previously installed air conditioner unit;
a tank adapted to collect condensed water from the air conditioner unit;
a pipe adapted to transfer the condensed water from the air conditioner unit to the tank;
a pressurized water generator assembly;
a sensor adapted to sense a pressure drop in the pressurized water generator assembly;
a filter adapted to eliminate contaminants from water pumped through the filter; and
an on-demand water pump adapted to send the water through the filter and to a faucet for dispensation.

17. The water generation system of claim 16, wherein the water generator assembly resides in a first housing that is separate from a second housing in which the previously installed air conditioner unit resides.

18. The water generation system of claim 16, wherein the sensor is connected to the on-demand water pump, wherein the sensor activates the on-demand water pump upon sensing activation of the faucet, wherein the activation of the faucet is the opening of a valve of the faucet.

19. The water generation system of claim 16, further comprising a water level sensor connected to the on-demand water pump, wherein the water level sensor de-activates the on-demand water pump upon sensing a water level in the tank is below a predefined threshold.

20. The water generation system of claim 16, wherein the sensor is positioned near the valve of the faucet and wherein the sensor activates the on-demand water pump upon sensing a drop in pressure in the pressurized water generator assembly that results from the activation of the valve of the faucet.
